(19) United States
(12) Patent Application Publication
(10) Pub. No.: US 2012/0281957 A1
(43) Pub. Date: Nov. 8, 2012

(54) PLASMONIC AND PHOTONIC RESONATOR STRUCTURES AND METHODS FOR LARGE ELECTROMAGNETIC FIELD ENHANCEMENTS

(75) Inventors: Maysamreza Chamanzar, Atlanta, GA (US); Ali Asghar Eftekhar, Ithaca, NY (US); Ali Adibi, Suwanee, GA (US)

(73) Assignee: Georgia Tech Research Corporation, Atlanta, GA (US)

(21) Appl. No.: 13/271,737

(22) Filed: Oct. 12, 2011

Related U.S. Application Data
(60) Provisional application No. 61/483,731, filed on May 8, 2011.

(51) Int. Cl. G02B 6/10; B82Y 20/00

(52) U.S. Cl. 385/131; 385/129; 977/773

(57) ABSTRACT

Devices for producing localized surface plasmon resonances are described having a plasmonic resonator and a photonic structure electromagnetically coupled to the plasmonic resonator. The device can include a hybrid photonic plasmonic resonator that contains plasmonic and photonic resonators, and are optionally coupled to a photonic waveguide, or a plasmonic resonator coupled directly to a photonic waveguide. The plasmonic resonator can be one or more nanoparticles. The devices can produce substantial increases in coupling efficiencies and sensitivity for use in several applications, including SERS and refractive index sensing.

### CROSS-REFERENCE TO RELATED APPLICATION

The present application claims the benefit of U.S. Provisional Patent Application Ser. No. 61/483,731, filed on May 8, 2011, and entitled “Plasmonic and Photonic Resonator Structures and Method for Large Electromagnetic Field Enhancements,” which is hereby incorporated by reference in its entirety as if fully set forth below.

### TECHNICAL FIELD

The various embodiments of the present invention relate generally to devices having photonic and plasmonic structures, and more particularly to hybrid plasmonic photonic resonators, plasmonic resonators on waveguides and photonic resonators, methods of using same, and apparatus containing same.

### BACKGROUND

Label-free optical sensing is of great recent interest, especially in biomedical research for sensing biomolecules or monitoring binding kinetics. In this technique, the target molecules need not be labeled, and their existence is directly sensed typically through the change of refractive index of the interaction medium. This label-free scheme eliminates the tedious preparation process for labeling the molecules and makes the sensing technique fast and simple. Different structures have been used to implement label-free optical sensing, such as surface plasmon resonance (SPR) based sensors, photonic waveguide and fiber based sensors, photonic travelling wave resonator sensors, and photonic crystal resonance based sensors. Each of these techniques is best suitable for a particular set of applications. Among all these different methods, SPR-based sensors have been widely used for label-free biomolecule refractive index sensing. Surface plasmon wave is formed through coherent oscillation of free electrons at a metal-dielectric interface. The electromagnetic energy of a surface plasmon mode is highly confined at the metal-dielectric interface. Thus, these modes are very sensitive to the refractive index changes of the dielectric medium. However, conventional SPR sensor systems are usually large and bulky because of the excitation and interrogation mechanism that is mostly done through prism coupling and angle interrogation.

With the increasing need for point-of-care diagnostics, new requirements have emerged for these label-free sensors such as compactness, portability, low power consumption, mass production, integrability, and multi-analyte detection capability. To address these requirements, different techniques have been introduced for the implementation of compact and portable sensors. There have been some efforts to excite SPRs through coupling from a photonic planar waveguide or fiber optics. The waveguide-based SPR sensors can be interrogated through monitoring the transmittance spectrum or through monitoring the coupling spectrum. The fiber based SPR sensors are formed typically by removing the fiber cladding (by side polishing the fiber) and depositing a thin metallic layer. This type of structure suffers from cross-polarization interference and different techniques have been introduced to alleviate this problem.

It has also been shown that surface plasmon waves can be excited in a metal-semiconductor micropillar cavity. In such a structure, the surface plasmon wave is excited at the metal-semiconductor interface inside the semiconductor where a gain medium is located. This structure is aimed to be used as an on chip laser. In another work, a silica microresonator covered with a thin metal film is used to excite surface plasmon modes inside the silica microresonator. It has been shown that relatively high quality factor (high-Q) surface plasmon modes can be excited in such microresonators. In both of these structures, the surface plasmon mode is excited inside the microresonator and is not accessible outside the structure for biosensing purposes.

Localized surface plasmon resonance structures such a metallic nanoparticles, nanoparticle dimers, and bowtie antennas in different shapes and materials exhibit very large field enhancements and have already been utilized for nonlinear photonic applications such as surface enhanced Raman spectroscopy (SERS). Their large field enhancements and ultra-small mode volumes permit enhanced light-matter interaction for applications in light generation and sensing. Typically, nanoparticles are dispersed in a solution or immobilized on a solid substrate, and excited using free-space illumination. Moreover, owing to the small extinction cross-section of such nanoparticles, efficient excitation of individual nanoparticles in a controlled manner is challenging. However, in spite of the large increase in the absorption and scattering cross section of the molecules attached to those nanoparticles, still only a small portion of the optical power can be coupled to these structures.

### BRIEF SUMMARY OF THE INVENTION

The various embodiments of the present invention provide devices comprising hybrid plasmonic photonic resonators, devices comprising plasmonic nanoparticles on waveguides and photonic resonators, methods of using such devices, and apparatus containing such devices.

An exemplary embodiment of the present invention can be a device that includes a hybrid plasmonic photonic resonator. The hybrid plasmonic photonic resonator can be a photonic resonator coupled to a plasmonic resonator. The photonic resonator can have a surface area SA_{PH}, and the plasmonic resonator can have has a surface area SA_{PL}. In one embodiment, the surface area of plasmonic resonator can be less than the surface area of the photonic resonator. The photonic resonator can be a microring, microdisk, microsphere, or microtoroid, and can be a material with a dielectric index that is larger than a dielectric index of a neighboring layer. In an exemplary embodiment, the photonic resonator can be silicon nitride or silicon.

The plasmonic resonator can be a material that supports a surface plasmon. In an embodiment, the plasmonic resonator can be gold, silver, copper, aluminum, or graphene. The plasmonic resonator can be a nanoparticle, and the nanoparticle can be a nanodisk, a nanosphere, a nanorod, a nanocage, or dimers thereof, or colloidal nanoparticles. The plasmonic resonator can be two or more nanoparticles, and the nanoparticles can be separated by a distance d, wherein d can be greater than the width of the nanoparticles. In an exemplary embodiment, d can be greater than five times the width of the nanoparticles.

In an embodiment of the present invention, the plasmonic resonator can be in direct contact with the photonic resonator, or the plasmonic resonator can be separated from the photonic resonator by a buffer layer. The buffer layer can be a material having a refractive index and the photonic resonator can be a material having a refractive index, and the refractive index of the buffer layer can be less than the refractive index of the photonic layer. In one embodiment, the buffer material is silicon dioxide, SiO₂.

In some embodiments of the present invention, the plasmonic resonator can be covered with a cladding layer. The cladding layer can be a sensing medium having a porous material selected to attract or trap a target molecule. In one embodiment, the sensing medium can be alumina, titania, or a polymer matrix.

Some exemplary embodiments of the present invention can also include a photonic waveguide that can be coupled to the photonic resonator. In one embodiment, the transmittance spectrum of light in the photonic waveguide can decrease at a resonance wavelength of the plasmonic resonator. In some embodiments, the photonic resonator has a high intrinsic Q value, and the high intrinsic Q value can be at least 10,000.

Some exemplary embodiments of the present invention can also include a plasmonic resonator of two or more nanoparticles. The nanoparticles can be separated by a distance that is the same as or greater than the width of the nanoparticles. In one embodiment, the distance between the plasmonic nanoparticles is at least five times the width of the nanoparticles.

According to another exemplary embodiment of the present invention, the device can have at least one plasmonic nanoparticle and a photonic wave guide. The photonic waveguide can be a dielectric material having a refractive index that is larger than the refractive index of a neighboring layer. In an exemplary embodiment, the photonic waveguide can be silicon nitride or silicon. The plasmonic nanoparticles can be a material that supports a plasmon resonance. In an exemplary embodiment, the plasmonic nanoparticles can be gold, silver, copper, aluminum or graphene. In an embodiment the device supports localized surface plasmon resonances in the vicinity of the nanoparticles.

According to another exemplary embodiment of the present invention, the plasmonic nanoparticle can be electromagnetically coupled to the photonic waveguide. The electromagnetic coupling between the photonic waveguide and the plasmonic nanoparticle can achieve a coupling efficiency of at least about 10%. The device can have two or more plasmonic nanoparticles, and the photonic waveguide couples light to each of the two or more plasmonic nanoparticles.

According to another exemplary embodiment of the present invention, the plasmonic nanoparticle reduces a transmission of light through the photonic waveguide at the resonance wavelength of the nanoparticle by at least 10%.

In an embodiment of the present invention, the photonic waveguide or photonic resonator can have holes in its surface. The holes can be spaced at intervals. In one embodiment, holes can be at regular intervals. The holes can be in a configuration, including a straight line or curve, or in an approximately symmetrical shape. In one embodiment, a plasmonic resonator cannot be on top of the hole, and can be found in an approximately central position between two or more holes.

### BRIEF DESCRIPTION OF THE DRAWINGS

FIG. 1 illustrates an embodiment of a device in accordance with exemplary embodiments of the present invention.

FIG. 2 illustrates an embodiment of a device in accordance with exemplary embodiments of the present invention.

FIG. 3a illustrates an embodiment of a device in accordance with exemplary embodiments of the present invention.

FIG. 3b illustrates cross section of the device in FIG. 3a at dashed box a.

FIG. 4 illustrates an embodiment of a device in accordance with exemplary embodiments of the present invention.

FIG. 5 illustrates an embodiment of a device in accordance with exemplary embodiments of the present invention.

FIG. 6a illustrates the normalized field profile for the Hₓ component of the even supermode for a device of the present invention.

FIG. 6b illustrates a normalized average Poynting vector for the field profile shown in FIG. 6a.

FIG. 7 illustrates the normalized radial field profile for a device of the present invention.

FIG. 8 illustrates the calculated resonance wavelength shifts versus refractive index changes based on differing buffer layer thicknesses for a device of the present invention.

FIG. 9 illustrates the sensitivity (S) and Quality Factor (Q₀) based on differing buffer layer thicknesses for a device of the present invention.

FIG. 10 illustrates a graph of Effective Index Change (EIC) versus buffer layer thickness for a device of the present invention.

FIG. 11 illustrates a hybrid photonic plasmonic structure in accordance with exemplary embodiments of the present invention.

FIG. 12 illustrates the electronic field intensity profile near a plasmonic nanoparticle in accordance with exemplary embodiments of the present invention.

FIG. 13 illustrates the intensity enhancement for three plasmonic nanoparticles in accordance with exemplary embodiments of the present invention.

FIG. 14 illustrates the reflectance for three plasmonic nanoparticles in accordance with exemplary embodiments of the present invention.

FIG. 15 illustrates the transmission drop for three plasmonic nanoparticles in accordance with exemplary embodiments of the present invention.

FIG. 16 illustrates the coupling efficiency for three plasmonic nanoparticles in accordance with exemplary embodiments of the present invention.

FIG. 17 illustrates a hybrid photonic plasmonic structure in accordance with exemplary embodiments of the present invention.

FIG. 18 illustrates the coupling efficiency spectrum for a hybrid photonic plasmonic structure in accordance with exemplary embodiments of the present invention.

FIG. 19 illustrates a smaller range of wavelengths for the coupling efficiency spectrum in FIG. 18.

FIG. 20 illustrates the coupling efficiency in a localized surface plasmon resonance mode of the gold nanoresonator plotted versus the intrinsic Q and the coupling Q for a device in accordance with exemplary embodiments of the present invention.

FIG. 21 illustrates a SEM image of a device in accordance with exemplary embodiments of the present invention.

FIG. 22 illustrates the scattering image of a device in accordance with exemplary embodiments of the present invention.

FIG. 23 illustrates the transmission through the waveguide in the device shown in FIG. 21.

FIG. 24 illustrates the resonance spectrum of the device shown in FIG. 21.

FIG. 25 illustrates a SEM image of a device in accordance with exemplary embodiments of the present invention.

FIG. 26 illustrates the field enhancement of three plasmonic nanoparticles in accordance with exemplary embodiments of the present invention.

FIG. 27 illustrates the field profile of a plasmonic nanoparticle in accordance with exemplary embodiments of the present invention

FIG. 28 demonstrates the transmission of the waveguide in accordance with exemplary embodiments of the present invention.

FIG. 29 demonstrates the phase shift induced by the plasmonic nanoparticle in accordance with exemplary embodiments of the present invention.

FIG. 30 illustrates a SEM image of a device in accordance with exemplary embodiments of the present invention.

### DETAILED DESCRIPTION

As stated above, the various embodiments of the present invention are directed to plasmonic resonators coupled to photonic materials, e.g. photonic waveguides and photonic resonators. Surface plasmons are generated at the surface of the plasmonic resonator in these devices by the effect of a photon of light from the photonic material. The plasmons represent the quantization of the oscillation of the electron density in a plasmonic material. That oscillation occurs at a wavelength of light referred to herein as the resonance wavelength. Plasmons generated in this manner can then go on to interact with a photon to produce a polariton, and can be used in surface enhanced Raman Spectroscopy, refractive index sensing, and in other applications.

In the present invention, a hybrid integrated planar photonic plasmonic resonator is described that enables much higher field enhancement and thus much higher absorption and scattering effective cross section by efficient coupling of the input light wave in a photonic waveguide or a microresonator to plasmonic nanoparticles. By using photonic resonators such as microring and microdisk resonators, the photonic resonator field enhancement can leverage the plasmonic resonator field enhancement in a double resonance hybrid plasmonic photonic structure. The hybrid structure can be used in optical nonlinear application where a large enhanced electromagnetic field is required to initiate a nonlinear process in optical signal processing and sensing applications such as Raman and Florescence sensing. It can also be used to enhance the performance of the linear applications such as refractive index sensing.

Embodiments of the present invention can include a hybrid photonic plasmonic ring resonator or other hybrid photonic plasmonic platforms. Portions of these embodiments can include a plasmonic material or resonator; a photonic material coupled with the plasmonic material including a photonic resonator, a photonic waveguide or both; a photonic waveguide; buffer layers; cladding layers; and other aspects described herein.

The photonic portion of the device in an exemplary embodiment of the present invention can be prepared on a platform material or substrate in the course of constructing the device. The materials for the photonic portion of the device can be a material known to support photonic wavelengths, typically a dielectric material. The dielectric material can be a material that has a refractive index larger than a neighboring layer, including the platform it is constructed upon, a cladding layer, or a buffer layer associated with the dielectric. In an exemplary embodiment, the photonic material is silicon-on-insulator (SOI) or silicon nitride, or silicon nitride. The photonic material can be used at different frequency ranges, including from UV to visible to infrared.

In one embodiment, the photonic portion of the device is a photonic resonator, also called a photonic microresonator. The photonic resonator can be in a shape that supports photonic amplification of light. The photonic resonator can be a microring, a microdisk, a microsphere, or a microtoroid. In another embodiment, the photonic portion of the device can be a photonic waveguide that carries incident light along a portion of the device. The device can also include both a photonic resonator and a photonic waveguide that is separate from and in addition to the photonic resonator. The photonic resonator and photonic waveguide can be composed of the same material or of different materials, and can be electromagnetically coupled to each other. The photonic portion of the device can have a width of a size recognized by a person of skill in the art. When the photonic portion is a photonic waveguide, the width of the waveguide can be less than or equal to about 10 micrometer. In an embodiment, the width of the waveguide can be less than or equal to about 5 micrometers. In another embodiment, the width of the waveguide can be less than or equal to about 3 microns, such as less than or equal to about 1 micrometer. When the photonic portion of the device is a resonator, the shape can determine the dimensions. The photonic resonator can have a radius, diameter or width across the resonator, wherein these measurements help describe the overall size of the resonator. When the resonator is a disk or spheroid, the diameter of the disk or spheroid can be less than or equal to about 100 micrometer. In an embodiment, the diameter of the disk or spheroid can be less than or equal to about 60 micrometers. In another embodiment, the diameter of the disk or spheroid can be less than or equal to about 30 micrometers, such as less than or equal about 20 micrometers. When the resonator is a ring or toroid, the radius from a centerpoint of the ring or toroid to the middle of the resonator can be less than or equal to about 50 micrometers. In an embodiment, the radius of the resonator can be less than or equal to about 30 micrometers, such as less than or equal to 15 micrometers. In another embodiment, the radius of the resonator can be less than or equal to about 10 micrometers, such as less than or equal to about 5 micrometers. The ring resonator will also have a width of the resonator of less than or equal to about 10 micrometer. In an embodiment, the width of the resonator can be less than or equal to about 5 micrometers, such as less than or equal to about 3 microns. The photonic resonator can also be described as having a surface area, calculated as understood by one of ordinary skill in the art. The surface area of the photonic portion, SA_{PH}, can encompass the photonic waveguide if no photonic resonator is present, but will otherwise be only the photonic resonator whether or not the device also comprises a photonic waveguide.

In an exemplary embodiment, the plasmonic resonator can comprise a material that can support a plasmon. These materials can include materials that one of skill in the art would recognize as supporting a plasmon. In an embodiment, the material can be gold, silver, copper, aluminum, or grapheme. In another embodiment, the material can be gold, silver, or copper. The plasmonic resonator can be a contiguous structure or a noncontiguous structure on the surface of the photonic material.

In the course of investigating exemplary embodiments of the present invention, the inventors discovered that the majority of the field enhancement for a plasmonic resonator that was coupled with a photonic resonator occurred at the edges of the plasmonic resonator. By changing from a plasmonic ring to a plasmonic particle, the field enhancement can be more focused in a narrower area as compared to the plasmonic ring.

In one exemplary embodiment, the plasmonic resonator can be a nanoparticle (which can also be referred to as a plasmonic nanoparticle or a plasmonic nanoresonator.) The nanoparticle can be almost any shape, including a nanodisk, a nanosphere, a nanorod, a nanocage, or dimers thereof, or colloidal nanoparticles. A plasmonic resonator can be more than one plasmonic nanoparticle, including two plasmonic nanoparticle, three plasmonic nanoparticle, four plasmonic nanoparticle, and so forth. The nanoparticles can be of the same or different shapes. When the plasmonic resonator has more than one plasmonic nanoparticle, the nanoparticles can be separated by at least a fraction of distance d, wherein d approximately equals the width of the nanoparticle, as measured parallel to the device surface and in the same direction toward the next nanoparticle. In an embodiment, the nanoparticles can be separated by at least the distance d. In another embodiment, the nanoparticles can be separated by at least three times the distance d, such as at least five times the distance d. When nanoparticles of different sizes are present, the average of the widths of the nanoparticles can be used as the value for d.

The dimensions of the plasmonic nanoparticle can be a size that one of skill in the art would recognize as effective for supporting a localized plasmon resonance. The size can depend on the shape of the plasmonic nanoparticle, but generally, the plasmonic nanoparticle can be less than or equal to about 500 nm in the largest dimension. In an embodiment, the nanoparticle can be less than or equal to about 250 nm in the largest dimension, such as less than or equal to about 200 nm in the largest dimension. The plasmonic nanoparticle also can be greater than or equal to about 50 nm in the largest dimension. In an embodiment, the nanoparticle can be greater than or equal to 75 nm in the largest dimension, such as greater than or equal to 100 nm in the largest dimension. The largest dimension of the nanoparticle is measured in a direction parallel to the device surface, i.e. width and length, and not perpendicular to the surface, i.e. height or thickness. The height of the nanoparticle can be less than or equal to about 100 nm. In an embodiment, the height of the nanoparticle can be less than or equal to about 50 nm. In another embodiment, the height of the nanoparticle can be less than or equal to about 30 nm, such as less than or equal to about 20 nm.

The resonance wavelength of the plasmonic nanoparticle can be varied based on the shape and the size of the nanoparticle. For example, the resonance wavelength of a nanoparticle can increase as the size of the nanoparticle increases. The resonance wavelength can also change based on the shape of the particle. By way of non-limiting examples, a nanodisk can exhibit a resonance wavelength of 650 nm, nanorods can exhibit a resonance wavelength of 700-800 nm, and nanocages can exhibit a resonance wavelength of 780 nm. These wavelengths can be modified by changing the size as well, as noted above. In an embodiment, a plasmonic resonator that has more than one nanoparticle can have nanoparticles that have the same size and same shape, that vary in size and have the same shape, that have the same size and vary in shape, and that vary in size and vary in shape. By varying the size and shape across the multiple nanoparticles on the device, different resonance wavelengths can be accessed in the same device at the same time.

The plasmonic resonator can also be described as having a surface area, calculated as understood by one of ordinary skill in the art. The surface area of the plasmonic resonator, SA_{PL}, can encompass the sum of the individual nanoparticles if more than one nanoparticle is present, and can include the surface area of just the plasmonic resonator when it is present as a uniform material on the surface of the photonic resonator.

The device of the present invention can also comprise a buffer layer that separates the plasmonic resonator from the photonic portion of the device. The buffer layer can be composed of materials known to one of skill in the art that does not interfere with the coupling between the plasmonic resonator and the photonic portion of the device. The buffer layer can be a material that has a refractive index RI_{B} that is less than the refractive index of the photonic material RI_{PH}. The refractive index of the buffer layer should be less than the photonic layer's refractive index in order to confine and guide the light in the high refractive index layer. The buffer layer's refractive index is chosen to be less than the photonic layer's refractive index so that the light is confined in the photonic core and then couples to the plasmonic mode through the buffer layer. In an exemplary embodiment, the buffer layer is SiO₂.

The device of the present invention can also comprise a cladding layer that can be on top of the plasmonic resonator and the device. The cladding layer can determine how the surface plasmon created at the plasmonic resonator interacts with the space or medium above it. In one embodiment, the cladding layer comprises a sensing medium. A sensing medium is a porous material selected to attract or trap a target molecule, compound, element or other structure. As a nonlimiting example, the cladding layer can be selected to have a porous material that selects for molecules of a certain size, or a material that traps compounds of a certain type. In an embodiment, the cladding layer can be a material that is alumina, titania, or a polymer matrix.

Another aspect of the devices of the present invention is the coupling of the photonic waveguide to the photonic resonator and/or to the plasmonic resonator. When a waveguide is present in a device having a hybrid photonic plasmonic resonator, the hybrid resonator is coupled to the photonic waveguide such that the coupling (or hopping/tunneling) of light from the waveguide to the resonator allows the light to propagate in the resonator. One of the advantages of the hybrid resonators is the strong field enhancement that can accompany a narrow resonance linewidth for the resonator. A high intrinsic quality factor, or Q-value, also described as Q₀, describes the ability of the resonator to achieve and maintain a high energy density and tight optical confinement of the light in the resonator. The intrinsic Q value of the devices can be at least about 5000, at least about 10,000, at least about 50,000, and at least about 100,000.

This Q value and the optical confinement of light can also be applied to devices having a photonic waveguide with plasmonic nanoparticles set on top of it. In one aspect of the present invention, the photonic waveguide with plasmonic nanoparticles on top can have better spectral efficiency, but can also have wider bandwidths. These devices, while producing higher field enhancements as compared to the prior art still produce lower field enhancements relative to the hybrid resonator coupled to a waveguide. This lower field enhancement can be increased by narrowing the width of the waveguide, and can also be increased by increasing the Q value by adding holes in the surface of the waveguide. The presence of these holes produces light-confining defects in the waveguide known as photonic crystal cavities, nanocavities, or nanobeam cavities. Inclusion of a plasmonic nanoparticle between holes on the waveguide can increase the coupling efficiency between the waveguide and plasmonic nanoparticle because the photonic crystals provide a high Q-value resonant light coupling. The plasmonic nanoparticle in general will not be placed on top of a hole, but will be placed between holes. The photonic waveguide can have holes in the surface in an arrangement and dimensions that creates a photonic crystal cavity. In one embodiment, the holes in the photonic waveguide occur at regular intervals. The holes can be arranged in a shape effective for creating a photonic crystal cavity. In one embodiment, the holes are created in a line that runs parallel to the length of the waveguide. In another embodiment, a line of holes perpendicular to the length of the waveguide can be created. The holes can be arranged to form an approximately symmetric shape, such as a line, circle, triangle, parallelogram, pentagon, hexagon, and so forth. Shapes created by the holes can also be repeated along the length of the waveguide, for example a series of lines, created by holes that run perpendicular to the length of the waveguide, can be repeated along the length of the waveguide.

The devices of the present invention which comprise a waveguide coupled to a resonator can also have a coupling quality value, or Q_{c}. Q_{c} can affect the propagation of light from the waveguide to the narrow linewidth resonator. Q_{c} can depend primarily on the distance between the edges of the waveguide and the resonator

In the devices of the present invention, the plasmonic resonator and plasmonic nanoparticles described above can be combined with the photonic resonators and photonic waveguides described above to produce hybrid integrated photonic plasmonic structures. These plasmonic photonic structures can achieve significant field enhancements, absorptions, and scattering cross-sections. These can be achieved by effective coupling of an input wavelength to the photonic waveguide or photonic resonator and then to the plasmonic resonator. While not wanting to be bound by theory, the plasmonic resonator and photonic resonator of the present invention, although described as being separate, appear to work as a uniform, monolithic structure rather than two separate structures. When a waveguide is side-coupled to a hybrid photonic plasmonic structure, the waveguide acts as if it were seeing only a monolithic structure. In designing the structures, the plasmonic and the photonic layers can be treated as two separate structures that are strongly coupled to each other, and the hybrid structure can then analyzed as a monolithic structure to finalize the optimization.

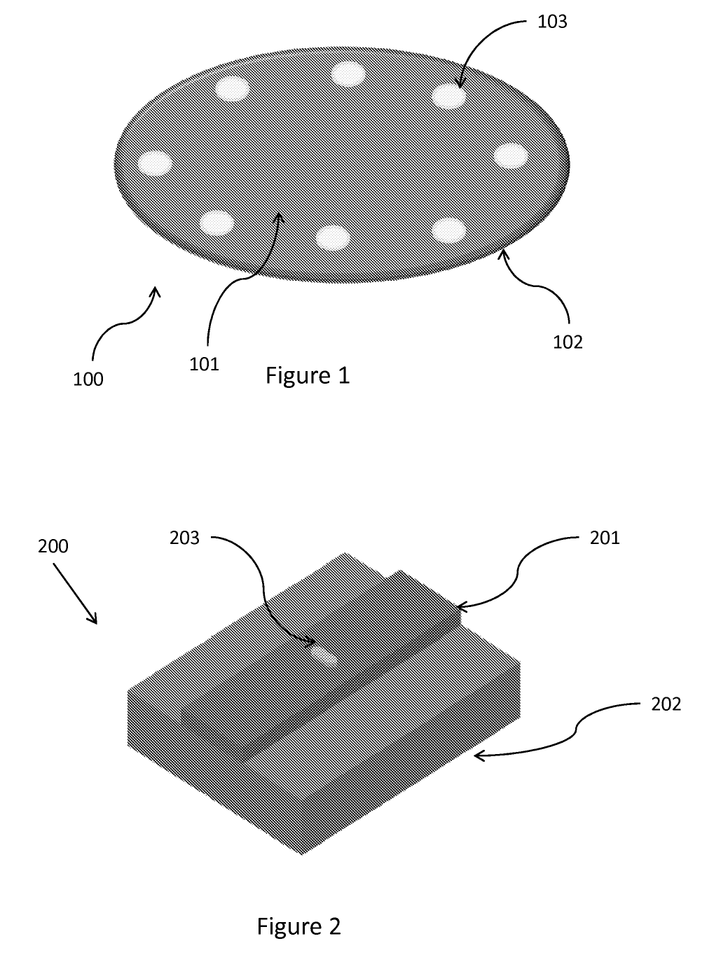

Several examples embodiments of the device can be described with reference to the figures. In one non-limiting example, FIG. 1 shows a device of the current invention. The device 100 comprises a photonic resonator 101, prepared on a platform, 102. Those of skill in the art will appreciate that the platform can be many types of material, including SiO₂. On the surface of the photonic resonator, 101, is a plasmonic resonator 103 in the form of several nanodiscs.

FIG. 2 shows another embodiment of a device of the present invention. In the device 200, a photonic waveguide 201 is placed on top of a platform 202. Onto the surface of the photonic waveguide 201 is placed a plasmonic resonator 203. Incident light from a light source can propagate through the waveguide 201, and the waveguide 201 will couple with the plasmonic resonator 203, as the wavelength of light approaches the resonance wavelength of the plasmonic resonator.

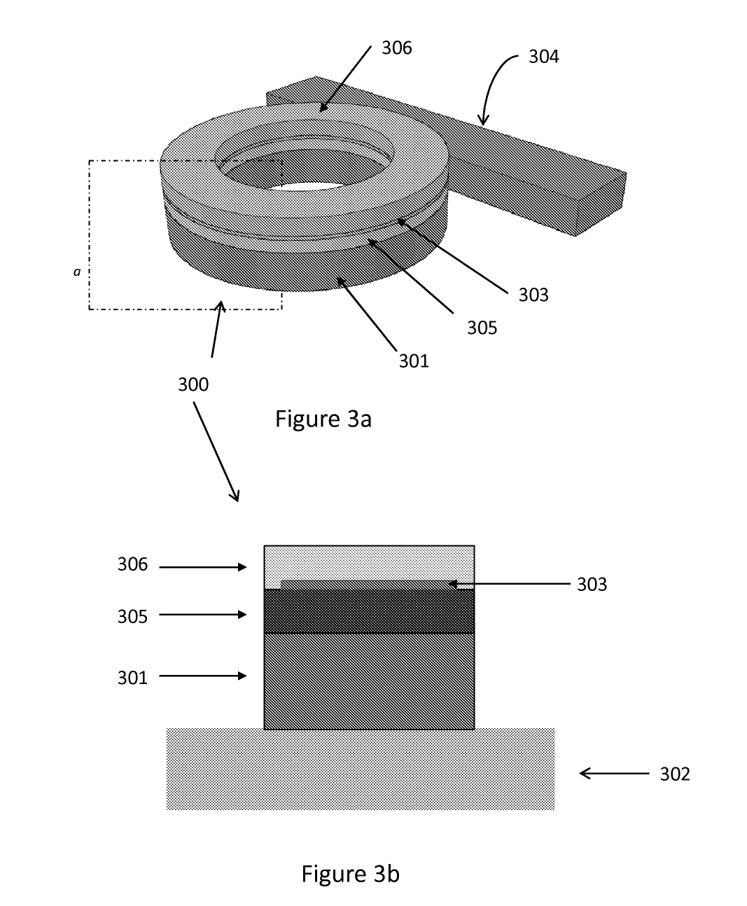

FIG. 3a shows another device of the present invention, and FIG. 3b shows a cross section of the ring portion in FIG. 3a as cut by the plane a. The device 300 has a photonic ring resonator 301 constructed on a typical platform 302. The photonic resonator 301 is electromagnetically coupled with the plasmonic resonator 303, and photonic resonator 301 and plasmonic resonator 303 are separated by a buffer layer 305. Atop the structure is placed a cladding layer 306. Also present in the device is a photonic waveguide 304 that is side coupled to the photonic resonator. In device 300, incident light from a light source can propagate through the waveguide 304. The light couples between the waveguide 304 and the photonic resonator 301 as the wavelength of incident light approaches the resonance wavelength of the plasmonic resonator 303. The ability and effectiveness of the coupling from the waveguide 304 to the plasmonic resonator 303 via the photonic resonator 301 can depend on several variables, including the distance between the waveguide and the photonic resonator, which affects Q_{c}, and the Q₀ value of the photonic resonator.

One of skill in the art would realize that parts of FIGS. 1 and 3a and 3b can be combined to yield different embodiments of the present invention. For example, the plasmonic resonator exemplified by FIG. 1 as comprising several nanodiscs (see 103 in FIG. 1) could replace the plasmonic resonator 303 of FIGS. 3a and 3b. Alternatively, the photonic resonator in FIG. 3a, in the form of a ring, could be replaced with a photonic resonator in the form of a disc, such as is shown in FIG. 1.

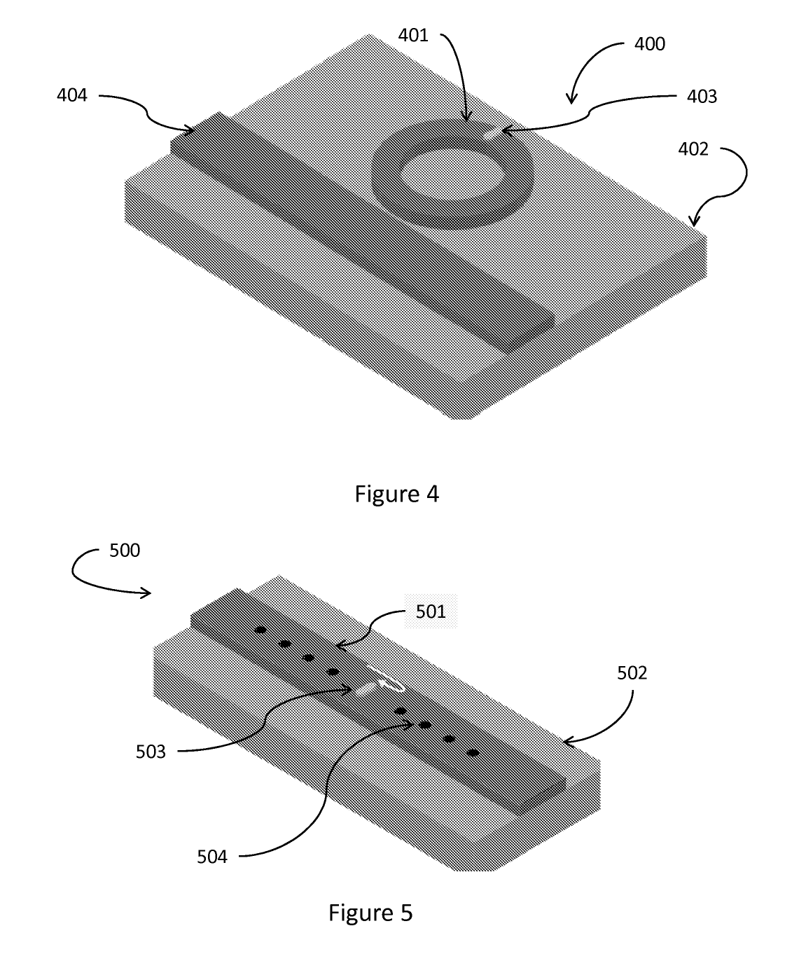

FIG. 4 further demonstrates one of these combinations. The device 400 has a photonic resonator 401 that is side-coupled to waveguide 404. The waveguide 404 and photonic resonator 401 are constructed on a typical platform 402. On top of the photonic resonator 401 is a plasmonic resonator 403 that is a single nanoparticle. As in FIGS. 3a and 3b, incident light from a light source can propagate through the waveguide 404. Light couples between the waveguide 404 and the photonic resonator 401 near the resonance wavelength of the plasmonic resonator 403.

FIG. 5 shows a device 500 of the present invention that is similar to the photonic waveguide in FIG. 2. The photonic waveguide 501, constructed on a platform 502, has within it holes 504 that create photonic crystal cavities. Light that propagates through waveguide 501 becomes confined in the photonic crystal cavity. The resulting surface plasmon generated at the plasmonic nanoparticle 503 will demonstrate increased field enhancements.

During the operation of a device of the present invention, a lightwave produced from a light source propagates through the photonic. At the resonance wavelength of the plasmonic nanoresonator, λ₀, the cloud of electrons of the plasmonic material begins to oscillate. At this point, the transmittance of light passing through the waveguide decreases. The reflectance in the waveguide is also at a minimum, and the amount of light that is coupled to the plasmonic resonator can be determined. Hence, at resonance, the transmitted light intensity will drop rapidly. Therefore, an analysis of the coupling efficiency of various embodiments of the present invention can demonstrate the surprising efficiency of the devices of the present invention.

Embodiments of the present invention can exhibit a decrease in transmittance of light at the resonance wavelength of at least about 5%, i.e. a drop from 1 to 0.95. In an exemplary embodiment, the decrease in transmittance of light can be at least about 10%. In another embodiment, the decrease in transmittance of light can be at least about 15%, such as at least about 20% or at least about 25%. In one nonlimiting example, the transmission drop was almost 50%. As additional plasmonic resonators are included in the device, the decrease in transmittance of light at the resonance wavelength can be at least about 10%, 20%, 30%, 40%, 50%, and so on, depending on the number of plasmonic resonators and efficiency of each.

Embodiments of the present invention also show very low levels of reflectance at the resonance wavelength. In an embodiment, the reflectance is less than or equal to about 3%, such as less than or equal to about 2%, and less than or equal to about 1%.

Low coupling efficiencies to plasmonic nanoparticles are a problem in prior art devices. The plasmonic nanoparticles have very small extinction cross section, limiting the coupling efficiency of light to their resonance modes when excited from free space. For example, when a lens is used to focus the lightwave down to a spot size of 5 μm to excite a free-standing gold nanorod having an effective radius of 21.86 nm and an aspect ratio of 3.9 (see Jain et al., “Calculated Absorption and Scattering Properties of Gold Nanoparticles of Different Size, Shape, and Composition: Applications in Biological Imaging and Biomedicine,” J. Phys. Chem. B 110, 7238-7248, (2006),) only about 0.17% of the input lightwave power is coupled to the plasmonic nanoparticle. The extinction cross section is the sum of scattering and absorption cross section. According to Jain, the absorption cross section is C_{abs}=1.97×10⁻¹⁴ m² and the scattering cross section is C_{sca}=1.07×10⁻¹⁴ m², which results in an extinction cross section of Cₑₓₜ=C_{abs}+C_{sca}=3.07×10⁻¹⁴ m². If a single nanorod with those specifications is excited, only 0.17% of the input power is removed by this nanoparticle and the rest passes through without coupling to the nanoparticle and is wasted. Similarly, recent work in Challener, et al., “Heat-assisted magnetic recording by a near-field transducer with efficient optical energy transfer,” Nature Photonics, Vol. 3, 220-224, (2009) showed that a theoretical coupling efficiency of about 8% could be attained, but it required the use of a planar solid immersion mirror to couple the light to a gold near field transducer.

In comparison, embodiments of the present invention have coupling efficiencies (denoted |k|² and defined by the equation |k|²=1−R−T, where R is reflectance and T is transmittance) that are much higher. In an embodiment, the devices containing a photonic waveguide with plasmonic nanoparticle can have a coupling efficiency of at least about 5%. In another embodiment, the coupling efficiency can be at least about 10%, at least about 15%, or even at least about 20%. Devices comprising a photonic resonator in combination with the waveguide exhibit even higher field enhancement due to narrower linewidth, so the coupling efficiencies can be even higher. In one non-limiting example, a coupling efficiency of 45% can be obtained for a single plasmonic nanoparticle atop a photonic resonator. In another non-limiting example, a coupling efficiency of 80% can be obtained.

Embodiments of the present invention can be constructed using techniques commonly used to prepare semiconductor and micrometer and nanometer scale devices, including but not limited to standard photolithographic techniques and chemical synthesis. These techniques can include but are not limited to electron beam lithography, interference lithography, ICP, patterning, photomasking, resistance etching, and so forth.

Embodiments of the present invention can be used in numerous applications. In one embodiment of the present invention, devices of the present invention can be used in refractive index sensing. The plasmon modes at the surface of plasmonic resonators are very sensitive to the refractive index of the surrounding medium. The change of refractive index at a surface plasmon changes the resonance wavelength. Plasmonic structures have been used as surface plasmon resonance (SPR) sensors, where the attachment of target molecules to the surface of a plasmonic structure changes the resonance. This change can be used in several applications, including for example monitoring binding kinetics. Also, plasmonic resonators comprising one or more plasmonic nanoparticles can be used for localized SPR (LSPR) sensing, where the attachment of the target analyte to the surface of the plasmonic nanoparticle results in a change of the localized resonance of the plasmonic nanoparticle. These nanoparticle-based sensors have shown a promise for the detection of very small amount of analyte. In contrast, prior art devices have shown the inefficient coupling of the lightwave, which has limited the signal-to-noise ratio and therefore has limited the detection limit.

Embodiments of the present invention can be used in surface enhanced Raman spectroscopy (SERS). SERS is used to study the transitions between molecular rotational and vibrational energy states when monochromatic light interacts with molecules, which results in the energy of the scattered light photons being shifted. SERS enhances Raman scattering via molecules adsorbed on, for example, rough metal surfaces or metal nanoparticle aggregates. The Raman signal enhancement can be related to the large electric fields generated near the metal surface due to localized surface plasmon resonances, but the signals strongly depend on the excitation light wavelength. To achieve a large Raman enhancement factor, the excitation light wavelength can be tuned in close proximity to the surface plasmon resonance. Ultrahigh Raman signal enhancements have been demonstrated on the order of 10¹⁰-10¹⁵. This large enhancement has been hampered by the low level of coupling efficiency to the localized surface plasmon resonance modes, which has limited the signal-to-noise-ratio in other devices.

The present invention can have a large impact on many other applications such as Raman spectroscopy and single molecule sensing that can be used for a variety of chemical and bio sensing applications. Considering the expanding market for the compact and low cost molecular and chemical sensing, this invention can serve as a very low cost and yet very sensitive solution for single molecule sensing. These applications can extend from medical test kits and pharmaceutical applications to chemical and gas sensing.

The present invention is exemplified by the following non-limiting examples.

### EXAMPLES

### Example 1

A biosensor device which used hybrid whispering gallery plasmonic-photonic microring resonator was constructed and theoretically investigated, as shown in FIGS. 3(a) and 3(b), for label-free sensing of biomolecules. The sensor consisted of a silicon nitride (Si₃N₄) dielectric traveling-wave ring resonator vertically coupled to a thin layer of metallic strip ring resonator on top covered by a porous alumina (p-Al₂O₃) which served as the sensor interaction medium. In this hybrid resonator, the surface plasmon mode was excited on top of the metallic layer in the porous cladding where the target molecules could efficiently interact with the enhanced electromagnetic field associated with the surface plasmon wave. One of the unique features of this hybrid resonator sensor was the large sensitivity of the surface plasmon waves and the relatively high quality factor Q because of the photonic ring resonator. Sensing of target molecules is performed by transcribing their adsorption to the interior walls of the porous sensor cladding layer into a change in the resonance wavelength of the resonator. Moreover, the sensor was very compact and could be implemented into an array format on a planar chip, which is highly desirable for lab-on-a-chip or point-of-care applications.

In practical applications, sensing systems which can detect different analytes at the same time are always needed, and there have been ongoing efforts for developing multi-analyte SPR imaging systems. The compact structure in FIGS. 3(a) and 3(b) could be used in a spectrally and/or spatially multiplexed scheme, in which many of these hybrid resonators are densely integrated on a chip. Each sensor can have a specific coating associated to a certain analyte. These resonators can be implemented in parallel, each coupled to a separate bus waveguide or they can also be implemented in series, where they are coupled to a common bus waveguide. In the case of a spectral multiplexing scheme, on-chip micro-spectrometers can be used to track small shifts in the resonance wavelength.

Principle of Operation

The schematic of the structure is illustrated in FIG. 3(a). It consists of a hybrid plasmonic-photonic ring resonator that is side-coupled to a photonic (bus) waveguide. FIG. 3(b) shows the side view of the hybrid resonator. The hybrid resonator is a multilayer ring resonator consisting of a dielectric layer (e.g. Si₃N₄) which acts as a dielectric resonator, and a surface plasmon ring resonator (in the form of a thin ring metal strip). The metal strip can be silver (Ag) here. The surface plasmon resonator and the photonic resonator can be separated by a buffer layer which can be silicon dioxide (SiO₂). The cladding can be a porous material (e.g. alumina (p-Al₂O₃)) which acts as the sensing medium where the target molecules are adsorbed. The substrate is silicon dioxide. Fourth structure in a t_{b}, R is the radius of the resonator, tᵣ is the Si₃N₄ film thickness, t_{b}, is the buffer layer thickness, tₘ is the metal layer thickness, and t_{c} is the cladding thickness.

The modes of the surface plasmon ring resonator and the dielectric photonic resonator in the structure shown in FIGS. 3(a) and 3(b) are strongly coupled to each other and thereby form a hybrid mode. The photonic waveguide was made of a Si₃N₄ ridge on the substrate and carried the optical light wave. This waveguide was side coupled to the resonator structure to excite the resonator mode. When the coupling conditions of the waveguide to the hybrid resonator was optimally engineered (i.e., under critical coupling condition), the transmittance spectrum of the waveguide exhibited a drop at the resonance wavelength of the hybrid structure. The excitation of the surface plasmon wave at the interface of the metal and the p-Al₂O₃ cladding resulted in a large enhancement of electromagnetic fields inside the cladding. When the target molecules were adsorbed to the walls of the pores inside the p-Al₂O₃ layer, the average refractive index of the cladding changed, and consequently, the resonance wavelength of the resonator shifted. This wavelength shift was tracked by monitoring the spectral location of the relatively high-Q resonance feature of the resonator at the output of the bus waveguide. The cladding porous layer not only acted as a host for target molecules, but also enhances the performance of the sensor. It has been shown that using a high-index porous cladding layer such as p-Al₂O₃ or p-TiO₂ on top of conventional bulk SPR sensors greatly enhances their response. Another advantage of using a p-Al₂O₃ cladding in a hybrid resonator sensor is that it facilitates the required phase matching condition between the surface plasmon mode and the dielectric guided mode.

The hybrid resonator in FIGS. 3(a) and 3(b) is a traveling wave resonator. To design such a resonator, the hybrid ridge waveguide formed the ring resonator and obtained the effective index of the hybrid guided mode at each wavelength. This hybrid waveguide supported a TM-like confined mode (i.e., magnetic field in the plane of the waveguide) which was the mode of interest. The effective index of this waveguide mode was then used as the initial guess to analyze the hybrid ring resonator using a rigorous FEM analysis. The design parameters for the waveguide structure include the dimensions and the material properties of different layers. In the hybrid sensor, the substrate was assumed to be SiO₂, with the refractive index of n=1.444. The dielectric resonator was assumed to be Si₃N₄ with n=2 for the operation of the device in the visible range of the spectrum. The buffer layer was assumed to be SiO₂, which can be easily deposited on top of Si₃N₄ during the fabrication. The metal layer was assumed to be Ag that supports surface plasmon modes in the visible range of the spectrum. Empirical material properties from P. B. Johnson and R. W. Christy, “Optical constants of noble metals,” Phys. Rev. B, vol. 6, pp. 4370-4379, December 1972, were used for the Ag film. The cladding layer was chosen to be porous alumina (p-Al₂O₃). The porosity of this layer was determined by the size and characteristics of the target biomolecules. In simulations, a porous Al₂O₃, with the pore radius of 7.5 nm and pore density of 5×10¹⁶ cm⁻² was used, which according to Maxwell-Garnett approximation has a refractive index of 1.59.

The thickness of the porous cladding layer (t_{c}) effectively determined the index of the medium above the metallic layer, which in turn affected the effective index of the surface plasmon mode. It has been shown that t_{c}=200 nm results in a high sensitivity in a bulk surface plasmon resonance sensor. Therefore, as a practically reasonable value, t_{c} was set at 200 nm. The selected value for t_{c} was a good approximation for several applications. The width of the structure (w) determined the effective index of the supermode and the phase matching condition through affecting the effective index of the surface plasmon mode and the dielectric ridge waveguide mode. The thickness of the Si₃N₄ ridge (tᵣ) together with the width of the structure determined the effective index of the ridge waveguide mode. The buffer layer thickness determined the amount of coupling between the dielectric ridge waveguide and surface plasmon polariton mode of the metal-cladding interface. When the buffer layer was very thick, the coupling was very weak and the supermode could be considered as the linear combination of two individual modes of the surface plasmon waveguide and the dielectric waveguide. As the buffer layer thickness was decreased, the two waveguide structures started to affect the modes of each other, and the coupling became strong. In the design, the weak coupling regime was initially used to satisfy the phase matching by the approximation of using the individual dispersion of these two waveguides, obtained from the FEM simulations to determine the width of the structure (w) for a fixed Si₃N₄ ridge thickness. Then, when the buffer layer thickness was decreased, (i.e., the strong coupling regime), the thickness of the Si₃N₄ ridge was adjusted so that the supermode of the hybrid structure was efficiently excited. Following this procedure, the dimensions of w=400 nm and tᵣ=200 nm were obtained from the simulations for t_{b}=120 nm. The thickness of the metallic layer was assumed to be tₘ=50 nm which is a typical thickness used in many bulk SPR sensors.

Using the above-mentioned geometrical parameters, the mode profile of the hybrid waveguide was studied first, which corresponds to the resonator. The hybrid waveguide had two supermodes, one with even symmetry and the other one with odd symmetry. The one with the even symmetry had lower loss and was of more interest. The effective index of the hybrid waveguide for this mode with the aforementioned dimensions and material properties was calculated to be n_{eff}=1.616−j0.0016 at the operation wavelength of λ₀=625 nm.

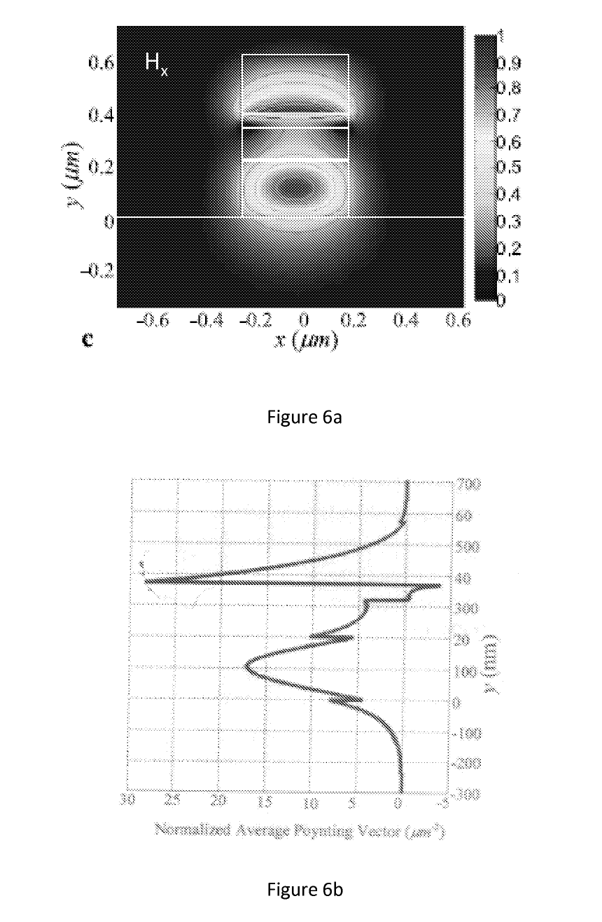

The normalized field profile for the Hₓ component of the even supermode of the hybrid waveguide is shown in FIG. 6(a), where the dielectric guided mode and the surface plasmon polariton of the metal strip were efficiently coupled to form a hybrid supermode. The normalized average Poynting vector, normalized to the total average mode power, in the propagation direction (z) is plotted in FIG. 6b as a cross section plot along the y axis (x=0), where the large field enhancement at the boundary of the metal strip and cladding as a result of excitation of surface plasmon wave is evident.

Once the effective index of the hybrid ridge waveguide was known, this effective index was used as an initial estimate in the ring resonator dispersion, i.e.,

k₀n_{eff}(2πR)=2mπ, (1)

to obtain the initial estimate for a rigorous FEM simulation of the hybrid traveling wave ring resonator. In this equation, ko=−2πr/λ₀ is the free-space wave vector, in is the azimuthal mode order, and n_{eff} is the effective index of the hybrid equivalent ridge waveguide obtained earlier.

As an example, an azimuthal mode number of m=114 gave the resonance wavelength λ=623.47 nm for a hybrid ring resonator with a radius of R=7.2 μm. This radius was chosen as a practical value for a compact structure. Note that if the radius was too small, the bend loss degrades the performance, and if the radius was very large, the size of the resonator becomes too large.

The axial symmetry of the structure was used to reduce the numerical computation to a two-dimensional analysis at a cross section of the resonator using a FEM code in cylindrical coordinates. The FEM analysis gives the resonant wavelength of λ=625.44 nm for to m=114, which is close to the approximated value of λ=623.47 nm obtained from (1), The free spectral range of the resonance mode of this structure is calculated from FEM simulations to be 4.54 nm.

The good agreement between the numerical result for the resonant wavelength obtained using rigorous FEM calculations and the result obtained from the effective index modeling using equivalent waveguide analysis suggested that the effective index modeling is a good approximation for the initial estimate of FEM analysis and is useful to design and analyze the structure.

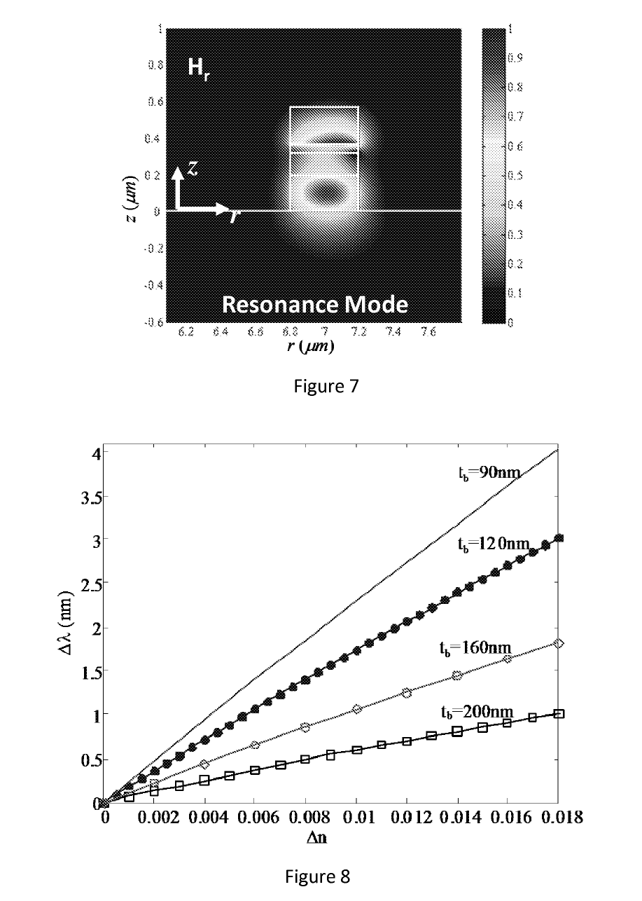

The normalized radial field profile (Hᵣ, component) for the hybrid resonator structure calculated using FEM simulations is plotted in FIG. 7. Similar to the case of the hybrid waveguide mode depicted in FIG. 2, it can be seen from FIG. 7 that the surface plasmon mode and the dielectric guided mode are strongly coupled to each other and form a supermode. The excitation of the surface plasmon polariton at the metal-cladding interface causes the enhancement of the electromagnetic field in the cladding interface where the resonator mode has maximum interaction with the target molecules.

Another interesting feature in FIG. 7 is that the mode is inclined towards the outer radius. In fact, the mode of the metal strip by itself is leaky at this radius without being coupled to a dielectric guiding structure, and the bend radius at which it can support a bound mode is much larger than what was used here. However, the hybrid structure in which a dielectric resonator and a plasmonic resonator are strongly coupled has the appropriate effective index to support a non-radiative mode.

Performance Analysis

In order to evaluate the performance of the hybrid resonator designed in the previous section as a refractive index sensor, the refractive index of the cladding layer was changed and the shift in the resonance wavelength using the FEM simulations was calculated. The initial refractive index of the p-Al₂O₃ was assumed to be 1.59, and it was increased to 1.608 in small steps of Δn=10. For the FEM simulations, the domain of the solution was meshed with triangular elements with quartic Lagrange functions. To ensure the convergence of the results, the average size of the elements in the simulation were: 15 nm in the Si₃N₄ layer, 12 nm in the buffer layer, 5 nm in the metal layer, and 6 nm in the cladding. The calculated resonance wavelength shift versus the refractive index change of the cladding for different buffer layer thicknesses (t_{b}) is plotted in FIG. 8. The slopes of each curve in FIG. 8 represents the sensitivity (S=Δλ/Δn) of the sensor for the corresponding value of t_{b}. It can be seen that when the buffer layer thickness was decreased, the sensitivity increased. In this case, the surface plasmon mode and the guided mode of the dielectric resonator are coupled more strongly, and a stronger field interacts with the molecules. On the other hand, as the buffer layer thickness was increased, the coupling between the two modes became weaker and the sensitivity decreases.

The detection limit of the sensor (DL) depends on the sensitivity as well as the resolution of the sensor,

DL=R/S (2)

The resolution, R, was proportional to the linewidth of the resonance (δλ), and inversely depended on the signal-to-noise ratio in the system (which depends on the detection mechanism used). To evaluate the performance of the proposed sensor, the linewidth of the resonance must also be investigated. In the structure, the sources of resonator energy loss that contribute to the broadening of the lineshape were mainly (i) the surface plasmon mode loss originating from the metal material loss, (ii) scattering loss from sidewall roughness, (iii) radiation loss, and (iv) the coupling of the energy to the waveguide. In calculations, considered the effect of surface plasmon mode loss was considered in view of the metal material loss from empirical data of Johnson et al. 1972. Also, the effect of scattering loss from the SIN ridge sidewalls was taken into account by assuming a propagation loss of 38 dB/cm, estimated from the current quality of fabrication of SiN ring resonators. The effect of coupling loss was considered by using the loaded Q at the critical coupling condition, i.e. Q_{L}=(Q₀⁻¹+Q_{c}⁻¹)⁻¹.

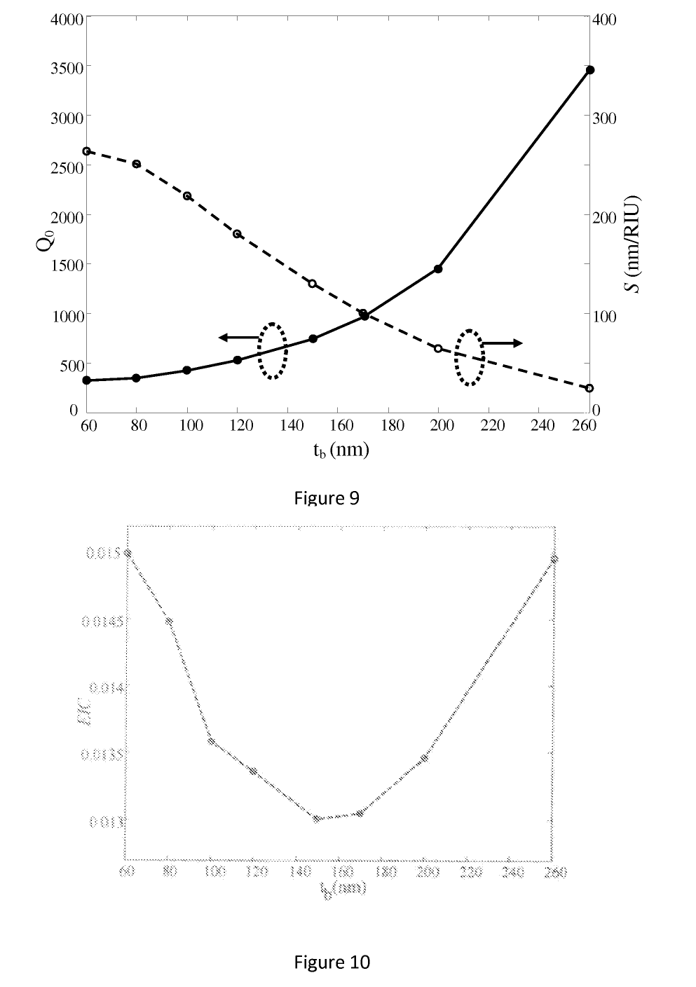

The sensitivity (S) and the resonator intrinsic quality factor (Q₀) are plotted in FIG. 9 versus the buffer layer thickness t_{b}. It can be seen that as t_{b}, increased, the sensitivity decreased because there would be less mode overlap between the surface plasmon mode and the dielectric mode. On the other hand, the resonator intrinsic quality factor (Q₀) increased as t_{b} is increased because the contribution of metal loss in the overall mode quality factor is decreased. These two effects compete in opposite direction, smaller Q₀ results in wider resonance peaks and more difficulty in detecting a small shift in the center wavelength of resonance, while larger S results in a larger shift in the resonance wavelength for a given index change. Due to this trade-off, there was an optimum value for t_{b}, which depended on design criteria and the overall desired performance.

To investigate the effect of this trade-off in the design of the proposed sensor quantitatively, define a performance parameter was design, called full width half maximum equivalent index change (EIC), as

$$EIC = \frac{δλ}{Δλ / Δ n} \qquad ( 3 )$$

where SA is the linewidth of the resonance when the loaded Q, under the critical coupling condition (i.e., Q_{L}=Q₀/2), is considered (δλ=λ₀/Q_{L}). The denominator in (3) is the sensitivity as defined earlier. The detection limit defined in (2) is proportional to SIC, and the proportionality factor depends on the overall signal-to-noise ratio in the detection mechanism. EIC parameter, as defined in (3), can be used for the assessment of the performance of a resonance-based refractive index sensing structure, and it can be interpreted as the detection limit for a full linewidth shift of the resonance wavelength. One key parameter in the design of the proposed structure is the buffer layer thickness. In order to investigate the effect of this parameter, EIC for the hybrid resonator with the parameters of R=7.2 μm, w=400 nm, t_{f}=200 um, tₘ=50 nm, t_{c}=200 nm is plotted in FIG. 10 for different buffer layer thicknesses. The large value of EIC at very small t_{b} (t_{b}<100 nm) is due to small values of S. On the other hand large values of EIC at large t_{b} (t_{b}, >200 nm) is due to small values of Q₀ (and thus broad resonance).

As is shown in FIG. 10, there was an optimum operation region around t_{b}=150 nm, where the EIC is minimum. FIG. 10 shows that the optimum operation point is not very sensitive to the buffer layer thickness around the optimum operation thickness. ‘Therefore, in practice slight changes of the buffer layer thickness during the fabrication of the device does not affect the performance adversely.

As a comparison, the parameter EIC is calculated for a fiber based SPR sensor to be EIC=0.014, which is comparable with the performance of this sensor. This means that the performance of this structure is on the same order as the other SPR sensing devices; however, this performance was achieved with a much more compact size and in an integrated platform.

Different Material Platforms and Fabrication

The hybrid resonator structure in FIG. 3a was designed in a Si₃N₄ material platform with Ag as the metal material and with alumina as the cladding sensing layer, and it was designed to work in the visible range of spectrum. However, it could be easily implemented using other materials such as silicon in a silicon-on-insulator (SOI) platform for use in infrared range of spectrum. The effective index of the dielectric guided wave resonator mode in Si was larger than that of the same guided wave resonator implemented using Si₃N₄. To satisfy the optimum coupling condition between the dielectric guided wave resonator mode in Si and the surface plasmon mode of metal-cladding interface either a higher index cladding material needs to be used, or the dimensions need to be changed. In the former case, a low porosity alumina, a porous titanium dioxide, or a porous silicon material can be used.

The choice of metal for the plasmonic layer is not limited to Ag. Other metals such as gold and aluminum can also be used. Gold is used widely in conventional SPR sensors, since it is more biocompatible, and unlike silver, it does not oxidize easily. However, it has more loss compared to silver in the visible range of the spectrum. The thickness of the metal layer can be decreased to alleviate this problem.

Using a porous layer in the structure of the proposed hybrid resonator causes the sensitivity of the resonator to increase. In fact, when the target molecules adsorb to the walls of the pores, they form a thin layer which causes the average refractive index to increase. The porous material provides more surface area for the adsorption of the target molecules and also enhances the interaction of the surface plasmon wave and the target molecules. The pore size provides a means of more specific sensing of the molecules according to their size. Also, special surface coating may be employed on the pore walls to provide more specific sensing mechanism. Other porous materials such as titanium dioxide (TiO₂) or polymer matrices can also be used as the sensing layer.

The fabrication of the device can be carried out by lithographically defining the ring resonator and bus waveguide on a Si₃N₄ film seated on SiO₂ substrate, followed by plasma etching of the Si₃N₄. Then, the entire structure is masked except the ring resonator region in a subsequent lithography step, and the metal layer (e.g. silver in our design) and subsequently aluminum are deposited followed by a lift off process. In the next step, the aluminum layer is chemically anodized to form a porous Al₂O₃. The alignment of the patterns in the two steps of lithography needs special precautions to assure good accuracy.

Coupling Issues

In the hybrid resonator system, the transmittance of the bus waveguide is used as the sensing signal. The structure has the best performance when it works under the critical coupling condition case. In the critical coupling regime in which the power in the waveguide was completely coupled to the resonator, the effective signal-to-noise ratio is maximized. The overall intrinsic quality factor of the hybrid resonator is determined by the material properties and the dimensions, especially the buffer layer thickness. These parameters are determined by the required performance measures such as the required detection limit and the minimum required linewidth. In some cases, satisfying the critical coupling condition with a straight waveguide side-coupled to the resonator might not be trivial due to small coupling. To address this issue and achieve the critical coupling, we can either use concentric coupling scheme (where the waveguide goes around the resonator) or implement the resonator as a racetrack (where the coupling length can be much longer).

Comparison with Other Sensing Mechanisms

Different implementations of SPR sensors have been proposed both in the bulk and using guided wave optics such as planar waveguides and fiber optics. The SPR-based sensors have shown a promise for fast and effective label-free biosensing and have been used in many biomedical studies. The sensitivity of such SPR sensors is usually very high, and the resonance linewidth, mostly determined by the surface plasmon resonance, is large. According to the EIC performance parameter, the performance of the present hybrid resonator sensor (EIC=0.013) is comparable to the performance of a fiber-based SPR sensor (EIC=0.014). However, the proposed structure is much more compact and can be implemented on a chip in an integrated platform which better conforms to the requirements of applications such as point-of-care biosensing. Another important point is that the linewidth of the resonance is much smaller for the present hybrid resonator compared to conventional bulk or guided-based SPR sensors. This makes the spectral multiplexing of the hybrid resonator more viable and many of them can be integrated on a chip to form a spectrally multiplexed array.

As another alternative technology, on-chip dielectric microresonators have been proposed for label-free index sensing. For example, a Si₃N₄-based microdisk with a radius of R=15 μm has been proposed with a sensitivity of S≈22.8 nm/RIU. The EIC can be calculated for that structure to be EIC˜˜0.007. Another example, is a glass-based microring resonator with a radius of R=60 mm which has a sensitivity of S≈141 nm/RIU. The EIC can be calculated for this structure to be EIC=0.0009. It can be seen that those structures have a larger size compared to the present hybrid resonator and the sensitivity is smaller than the present hybrid resonator in the former case, and comparable with the sensitivity of the proposed structure in the latter case. However, the present resonators have better performance in terms of the EIC parameter due to their extremely narrow resonance linewidth. Theoretically, these dielectric resonators have shown a promise for ultra-small detection limits; however, in practice, there are challenges in implementing these resonators mainly because they are sensitive to fabrication imperfections (especially the surface roughness). The resonance linewidth of a purely dielectric resonator is typically very small. Therefore, their spectral efficiency when a wideband source is used is small, making them more suitable for applications in which a tunable laser source can be used. Although extremely small resonance linewidth results in better detection limits, it makes the device more sensitive to environmental changes such as thermal drift and drift of the source. In contrast, the present hybrid resonator has a wider resonance linewidth in comparison with a dielectric resonator and has a higher spectral efficiency when used with a wideband source. Besides the simplicity of the system and the spectral efficiency, another advantage of using a wideband source is that the output spectrum can be monitored in real-time when the sensor is integrated with a micro-spectrometer, without repeatedly scanning the spectrum. This makes the study of kinetic changes possible.

### Example 2

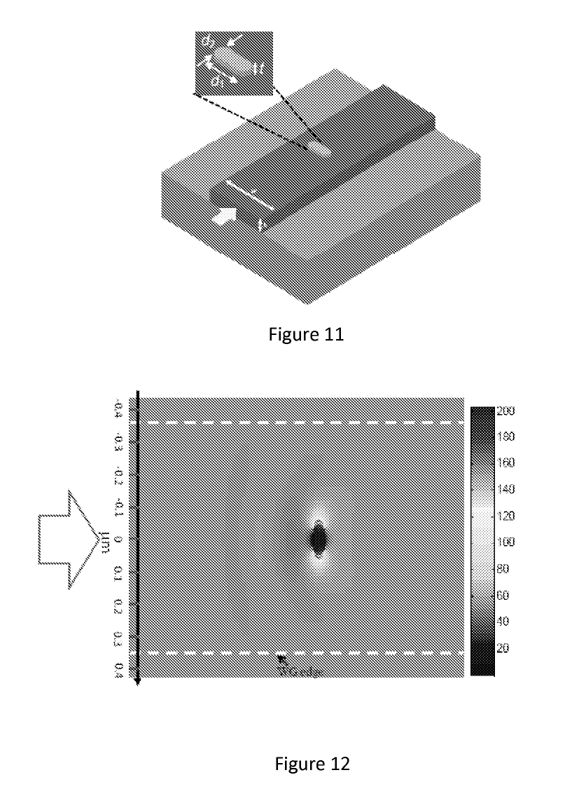

The schematic of the hybrid plasmonic-photonic structure consisting of a silicon nitride (Si₃N₄) ridge waveguide integrated with a gold nanorod on top is shown in FIG. 11. The substrate is silicon dioxide (SiO₂). The photonic waveguide with a cross section of (wxh) supports a transverse electric (TE-like) mode over a spectral range that covers the resonance of the plasmonic resonator. The ridge waveguide carries the light and the evanescent tail of the guided mode excites the plasmonic resonatormode. The plasmonic resonatoris assumed to be a gold nanorod with dimensions of (d₁×d₂×t), where t is the thickness of the gold nanorod. The radius of curvature of the nanorods is assumed to be half of its width, i.e., (d₂/2). Although we have considered a gold nanorod as the plasmonic resonator, other types of nanoparticles can also be used in the same hybrid structure, and the design, analysis, and implementation will follow the same procedure. Silicon nitride is considered as the material for ridge waveguide since it is transparent over a large spectral range from visible to infrared, and at the same time has a relatively large refractive index. To analyze and design the structure shown in FIG. 11, a model based on scattering analysis is employed. Also, finite difference time domain analysis (FDTD) is used to numerically analyze the structure. The hybrid structure consisting of a single nanoparticle vertically coupled to a ridge waveguide can be modeled as a standing wave resonator coupled to the waveguide. Part of the incident wave is coupled to the LSPR mode of the nanoresonator; the rest is either reflected or transmitted through the waveguide. The reflected power ratio is indicated by R, the transmitted power ratio is indicated by T. The plasmonic resonator stores light energy resulting in a very large field enhancement in the near field region. Two major loss mechanisms cause the decay of the stored energy in the nanoresonator mode. Part of the stored energy is lost due to the internal metal material loss, and part of it is radiated either to the substrate or to the surrounding medium.

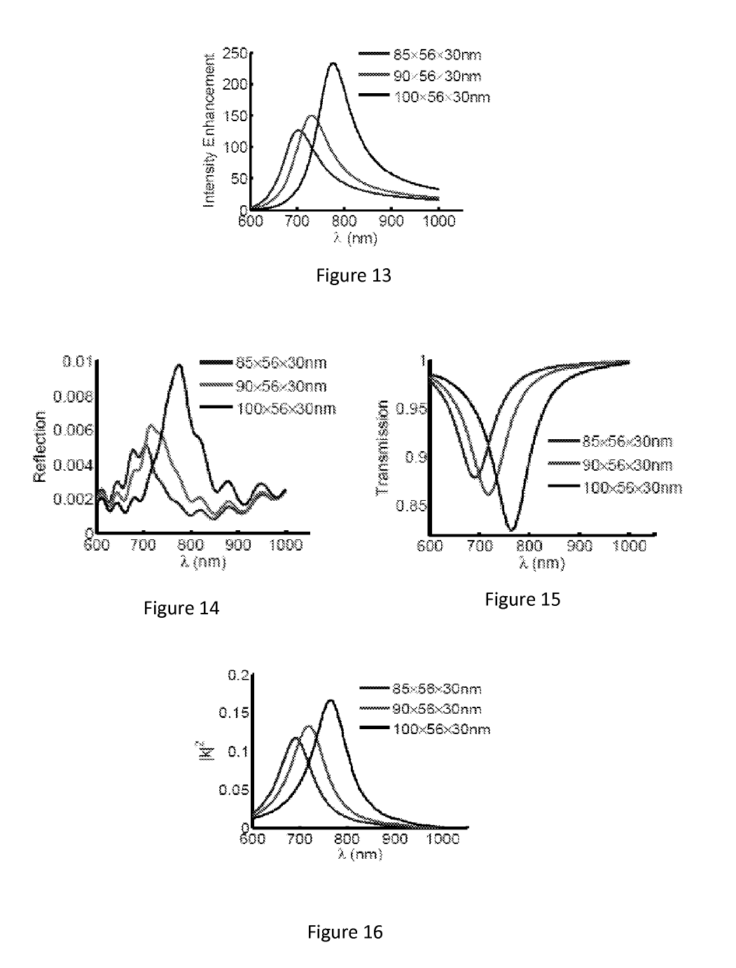

FDTD analysis was used to simulate the hybrid structure and optimize the coupling efficiency. As an example, a snapshot of the electric field intensity profile near a plasmonic nanorod with dimensions of 90 nm×56 nm×30 nm integrated on a ridge waveguide with dimensions of 700 nm×200 nm at the resonance wavelength of λ₀=731 nm is plotted in FIG. 13. The snapshot is taken halfway through the nanorod thickness, and it is normalized to the maximum field intensity in the same plane when there is no nanoresonator. It can be seen that the LSPR mode of the plasmonic nanorod on the waveguide is excited and the field intensity near the nanorod tips is highly enhanced.

In order to show the spectral response of the nanoresonators in the near field region, the electric field intensity spectrum is plotted in FIG. 13, at a point that is 2 nm away from the edge of the nanorod and halfway through its thickness for three different nanorods, each one on a 700 nm×200 nm Si₃N₄ ridge waveguide. In each case, the electric field intensity is normalized to the electric field intensity on a waveguide without a nanorod.

A large field intensity enhancement is observed near each nanorod tip. The nanoresonator resonance can be observed as a drop in the transmission of the waveguide, and also as a peak in the reflection spectrum. At the resonance, part of the input power is coupled to the LSPR mode of the nanoresonator and the rest of it is either transmitted through the waveguide, or is reflected back toward the source. At the resonance, the extinction cross section is at a maximum, which means that the sum of absorption and the scattering cross sections are at a maximum. Therefore, the nanoresonator acts as a stronger perturbation and the reflection is large. The reflection and the transmission spectrum for the three structures are plotted in FIG. 14 and FIG. 15, respectively. It can be seen that in each case, the transmission shows a drop near the resonance of the nanorod, and the reflection has a peak. The reflection at the resonance is less than 1% in each case. The oscillations in the reflection spectra are due to interference effects. In each case, the maximum extinction at the output of the waveguide is much larger than the reflection peak.

The difference is the amount of power that is coupled to the LSPR mode of the nanorod. The coupling efficiency spectrum can be obtained from the difference between the normalized incident power and the reflection and the transmission. The coupling efficiency spectrum for the three hybrid structures is shown in FIG. 16. The coupling efficiency has a resonance peak at the resonance wavelength of each plasmonic nanoparticle. The maximum coupling efficiency can be as high as 16.6% for a (100 nm×56 nm×30 nm) gold nanorod integrated on a ridge waveguide of dimensions (700 nm×200 nm), which means that about 16.6% of the input power is coupled to the LSPR mode of the plasmonic nanoparticle. The results are summarized in Table 1.

TABLE 1

| | | | | Trans- | |
|---|---|---|---|---|---|
| Nanoparticle | | | | mittance | Coupling |
| dimensions | | Intensity | | through | Efficiency |
| (nm) | λ₀ | enhancement | Reflection | waveguide | \|k²\| |
| 85 × 56 × 30 | 689 | 125 | 0.5% | 0.88 | 12% |
| 90 × 56 × 30 | 717 | 150 | 0.6% | 0.86 | 13.8% |
| 100 × 56 × 30 | 762 | 240 | 0.9% | 0.82 | 16.5% |

### Example 3

The resonance wavelength of the hybrid waveguide plasmonic resonator can be changed by varying the size of the nanoparticle on the surface of a photonic waveguide. Two devices were prepared using standard lithographic techniques. A nanoparticle was placed on the surface of each waveguide, and a broadband light source covering wavelength range of 500 nm to 1700 nm was made to pass through the waveguide with a power spectral density of −54 dBm/nm. The detection was done with only 1 second integration time. These results are shown in Table 2.

TABLE 2

| | Waveguide | Nanoparticle | |
|---|---|---|---|
| | width (nm) | dimension (nm) | λ₀ (nm) |
| Device 1 | 864 | 142 × 56 × 27 | 839 |
| Device 2 | 855 | 120 × 56 × 27 | 734 |

### Example 4

The coupling efficiency |k²| for the generation of the plasmon can be changed by varying the width of the waveguide of the nanoparticle on the surface of a photonic waveguide. Three devices were prepared using standard lithographic techniques. A nanoparticle was placed on the surface of each waveguide, and a broadband light source covering wavelength range of 500 nm to 1700 nm was made to pass through the waveguide. The extinction was measured at the resonance peak wavelength in each case. Coupling efficiency was determined by subtracting the percentage of reflectance and percentage of transmittance from 1, i.e. |k²|=1−R−T. The results are shown in Table 3.

TABLE 3

| Nanoparticle | Waveguide | Coupling |
|---|---|---|
| dimensions (nm) | width (μm) | efficiency \|k²\| |
| 120 × 56 × 27 | 3.95 | 2.8% |
| 120 × 56 × 27 | 1.95 | 4.9% |
| 120 × 56 × 27 | 0.855 | 7.8% |

### Example 5

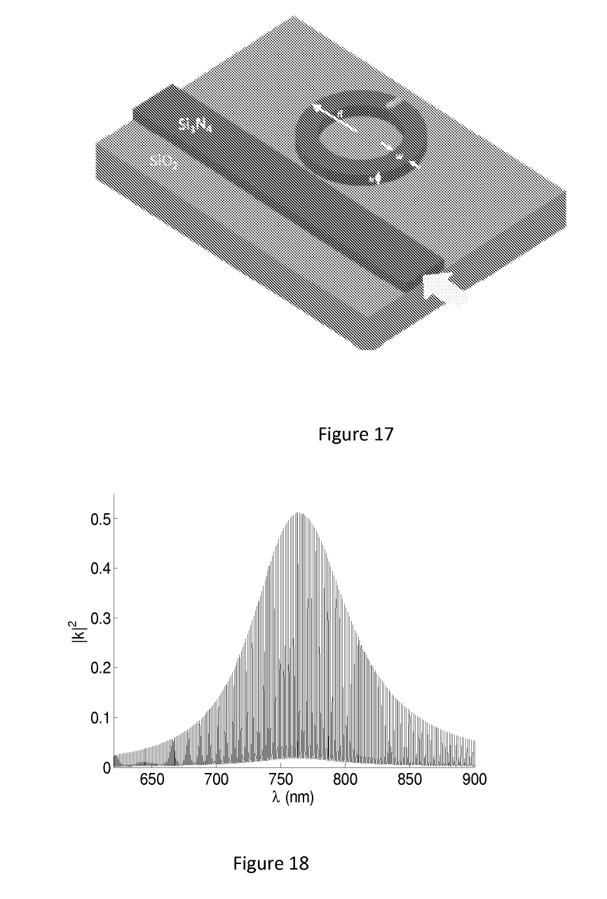

The schematic of a hybrid plasmonic-photonic double-resonator structure is shown in FIG. 17. It consisted of a silicon nitride (Si₃N₄) microring resonator integrated with a gold nanorod. The substrate was silicon dioxide (SiO₂). A photonic bus waveguide was used to deliver the lightwave to the hybrid resonator structure. When the lightwave was coupled from the bus waveguide to the hybrid resonator structure, it circulated around the dielectric microring resonator and gets enhanced, and gradually couples to the LSPR mode of the plasmonic resonator. The photonic microresonator had a cross section of (w×h) and a radius of R. The plasmonic nanorod had dimensions of (d₁×d₂×t), and was assumed to be made from gold. The radius of curvature of the nanorod was assumed to be half of its width, i.e., (d₂/2). The polarization of interest was TE-like with an electric field parallel to the longer dimension of the nanorod.

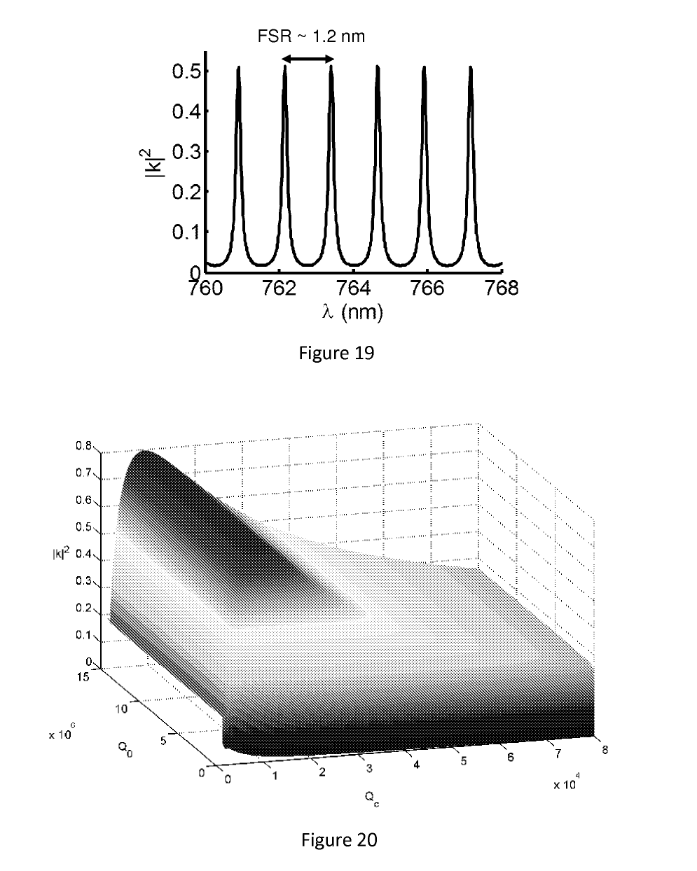

This hybrid structure was designed and optimized for an assumed intrinsic Q of Q₀=15000 for the photonic microresonator. The coupling efficiency spectrum is plotted in FIG. 18, as the coupling efficiency, |k|², versus wavelength. The envelope of the coupling efficiency spectrum followed the broadband resonance feature of the plasmonic resonator SPR mode on an equivalent waveguide. As shown in FIG. 19, this broadband resonance feature was sampled by the sharp resonances of the photonic microresonator. Using the proposed hybrid double-resonator structure, more than 50% coupling efficiency was possible to the plasmonic resonator over several modes of the hybrid double-resonator structure, which were separated by the free spectral range (FSR). The coupling efficiency of more than 50% to an individual gold nanorod, which was achieved in the hybrid structure, was more than two orders of magnitude improvement compared to less than 0.2% coupling efficiency when the nanorod is excited using free space optics. Besides the highly improved coupling efficiency, the structure is alignment-insensitive, and the plasmonic resonator integrated on the photonic microresonator can be easily excited once the lightwave is launched into the bus waveguide.

A global optimization was carried out to find out the effect of the intrinsic Q of the photonic microresonator and the coupling Q between the waveguide and the hybrid resonator structure. In FIG. 20, the coupling efficiency to the localized surface plasmon resonance mode of the gold nanoparticle is plotted versus the intrinsic Q and the coupling Q. It can be seen that for each intrinsic Q value, there existed an optimum coupling Q, for which the coupling of lightwave to the plasmonic resonator mode is maximum. Also, it can be seen that by increasing the intrinsic Q, the coupling efficiency was increased. Even modest values of an intrinsic Q of Q₋₀=1.35×10⁵ and a coupling Q of Q_{c}=9.2×10³ resulted in a coupling efficiency of about 75%.

### Example 6

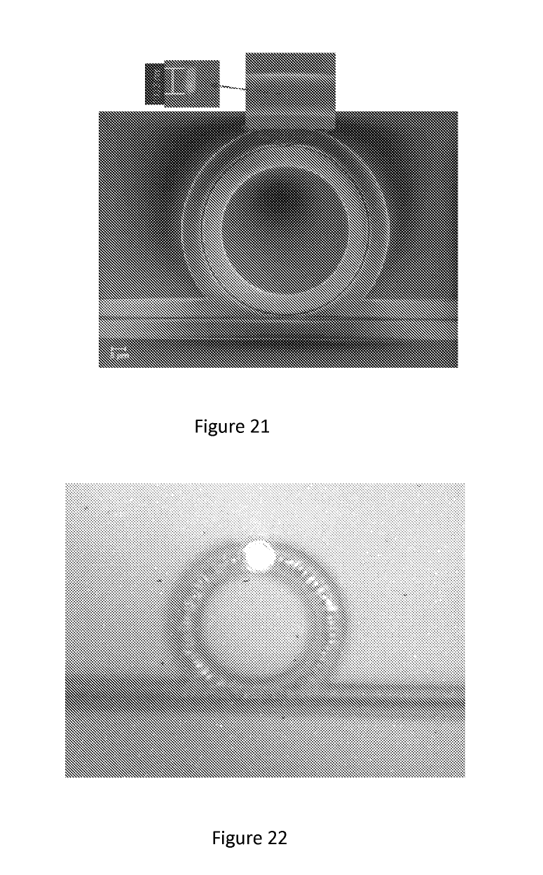

A hybrid plasmonic resonator photonic microresonator was fabricated using standard lithography procedures. The device consisted of a photonic microresonator constructed of Si₃N₄ and integrated with a gold nanorod. An enlarged image of the nanorod is shown in the inset of FIG. 21.

The top scattering image of the hybrid double-resonator is shown in FIG. 22 at a resonance wavelength of λ₀=775.05 nm. It can be seen that the LSPR mode of the plasmonic nanorod was excited. The plasmonic resonator was a gold nanorod of dimensions (117 nm×56 nm×30 nm) integrated with a Si₃N₄ microresonator of radius R=20 μm.

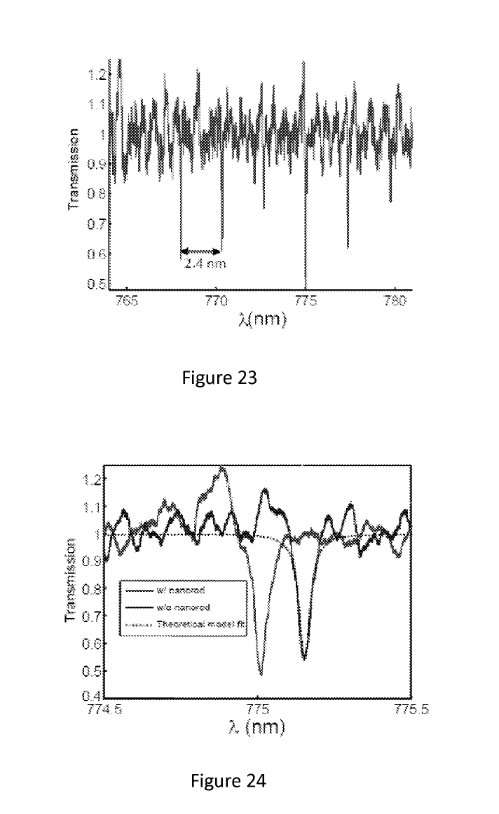

The transmission of light from the bus waveguide side-coupled to the hybrid double-resonator is shown in FIG. 23. It can be seen that the hybrid resonator had several modes separated with a free spectral range (FSR) of 2.4 nm.

The enlarged resonance of the hybrid plasmonic-photonic microresonator at a wavelength of λ₀=775.05 nm is shown in FIG. 24. The resonance spectrum of a similar structure without a nanorod is shown in the same figure. Comparison of these results with the theoretical model showed that a coupling efficiency of |k|²=10% was achieved for a single gold nanorod.

### Example 7

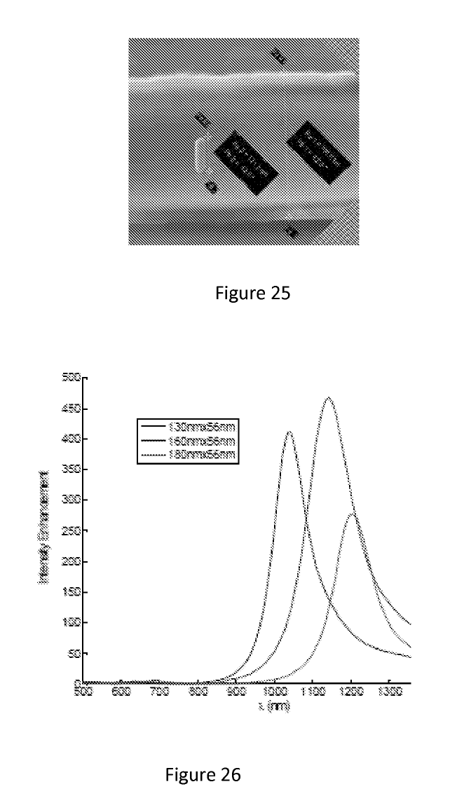

LSPR modes of nanoparticles can be excited using the evanescent tail of guided modes. Such a tight coupling of plasmonic nanoparticles on a photonic integrated circuit can enable efficient excitation of LSPR modes in a controlled manner. A structure analogous to FIG. 11 is shown in FIG. 25, and consists of a Si₃N₄ ridge waveguide (h=200 nm, w=700 nm) constructed on a SiO₂ substrate with an electron-beam lithographically (EBL) fabricated gold nanorod on top of the waveguide. The gold nanorod has a length (i.e. d₁ in FIG. 11) of 171 nm. A two step EBL process was used where in the first step Si₃N₄ patterns were defined and then etched using inductively coupled plasma (ICP) etching. The second step EBL was used for defining nanorod patterns and was followed by metal lift-off. It can be seen from FIG. 25 that good alignment accuracy was achieved to fabricate the gold nanorod on the Si₃N₄ optical ridge waveguide.

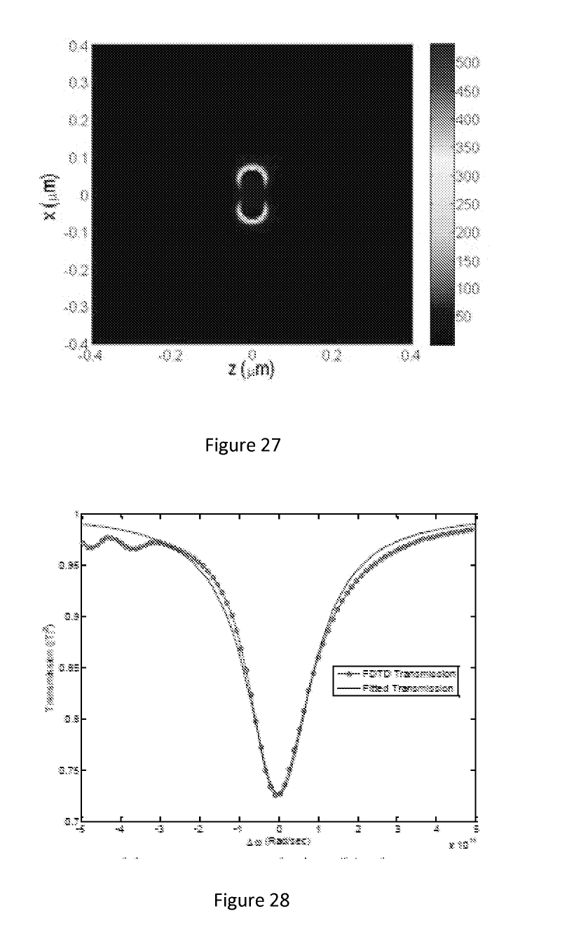

Finite Difference Time Domain (FDTD) analysis method was used to simulate the hybrid structure. The incident field is launched into the waveguide input. Three different sizes of d₁=130 nm, 160 nm, and 180 nm of nanorods with the lateral dimension of d₂=56 nm and a thickness of t=20 nm were investigated. The lateral dimension (d2) and the thickness (t) were fixed for all the different cases studied. The field enhancement at a point 2 nm away from the longer axis of the nanorod was calculated in reference to the Si₃N₄ waveguide and is shown in FIG. 26. At the resonance, very large field enhancements could be achieved. The resonance frequency redshifts as the size of the nanorod was increased. The near field profile of the LSPR mode for the 130 nm×56 nm×20 nm gold nanorod on the Si₃N₄ waveguide is shown in FIG. 27, which suggested that large field enhancements could be achieved near the edge of gold nanorods.

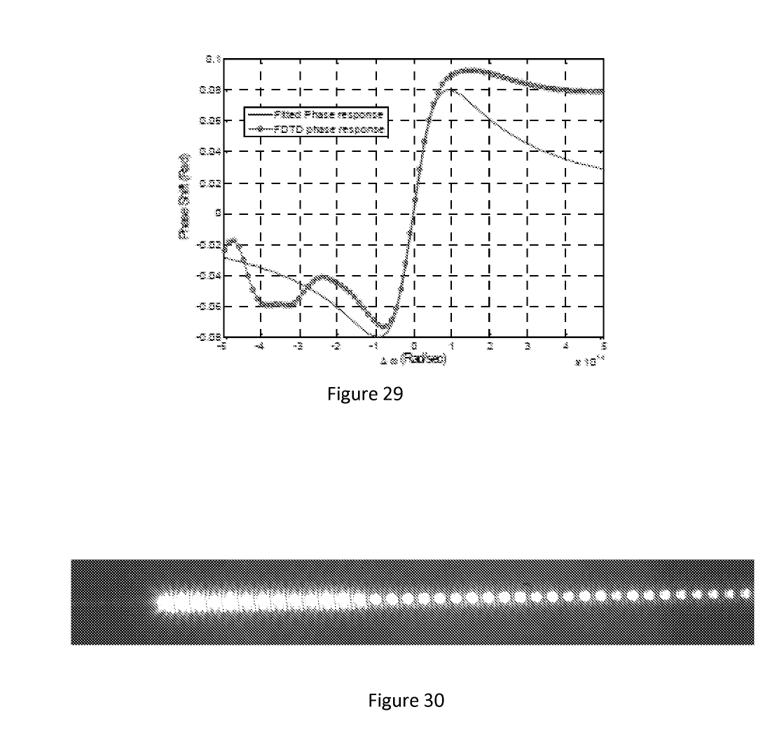

The transmission of the waveguide and the phase shift induced by the 130 nm×56 nm×20 nm gold nanorod is shown in FIG. 28 and FIG. 29 respectively. The phase response in FIG. 29 shows that at resonance a zero phase shift is contributed by the plasmonic nanorod. This means that the nanorod is undercoupled.

The resonance of this gold nanorod on the Si₃N₄ waveguide structure was modeled by assuming a Lorentzian lineshape. In this case the transmission of the waveguide was obtained as,

$$T = \frac{j 2 ( ω - {ω}_{0} ) / {ω}_{0} + \frac{1}{{Q}_{0}} - \frac{1}{{Q}_{c}}}{j 2 ( ω - {ω}_{0} ) / {ω}_{0} + \frac{1}{{Q}_{0}} + \frac{1}{{Q}_{c}}} \qquad ( 4 )$$

where ωₒ it is the resonance frequency; Qₒ is the intrinsic quality factor of the nanoplasmonic resonator; and Q_{c}, is the coupling quality factor which determines the level of coupling of light to the plasmonic nanorod. The transmission and the phase response in FIGS. 28 and 29 are fitted to the amplitude and phase for a Lorentzian lineshape given by Eq. 4 resulting in Qₒ=9.94 and Q_{c}=124.43. It can be seen that at frequencies off the resonance, the phase response deviates from the Lorentzian model. Therefore, the proposed model is valid near the resonance. Similar analysis for a 160 nm×56 nm×20 nm gold nanorod gives Qₒ=8.33 and Q_{c}=81.48. It can be seen that the coupling Q was still about 10 times larger than the intrinsic Q. Even in this non-optimized structure, the individual nanoparticle interacted efficiently with the optical guided wave.

### Example 8

A Si₃N₄ waveguide having dimensions of 600 nm wide×200 nm thick was constructed on a SiO₂ platform, and 37 gold nanoparticles, each 200 nm×60 nm×20 nm were deposited on the surface. The nanoparticles were separated from each other by an average distance of 11 μm. Light propagating down the waveguide produced an LSPR in each and every nanoparticle on the waveguide, as shown in FIG. 30.

While the exemplary embodiments of the invention have been described, it will be understood that those skilled in the art, both now and in the future, may make various improvements and enhancements, which fall within the scope of the claims that follow. These claims should be construed to maintain the proper protection for the invention first described.

What is claimed is:

1. A device comprising a hybrid plasmonic photonic resonator, wherein the hybrid plasmonic photonic resonator comprises a photonic resonator coupled to a plasmonic resonator,
wherein the photonic resonator has a surface area SA_{PH}, the plasmonic resonator has a surface area SA_{PL}, and SA_{PL} is less than SA_{PH}, and
wherein the plasmonic resonator comprises at least one nanoparticle.

2. The device of claim 1, wherein the nanoparticle comprises a nanodisk, a nanosphere, a nanorod, a nanocage, or dimers thereof, or colloidal nanoparticles.

3. The device of claim 1, wherein the photonic resonator comprises a microring, a microdisk, a microsphere, or a microtoroid.

4. The device of claim 1, wherein the plasmonic resonator is in direct contact with the photonic resonator.

5. The device of claim 1, wherein the plasmonic resonator is separated from the photonic resonator by a buffer layer,
wherein the buffer layer is a material having a refractive index RI_{B}, the photonic resonator is a material having a refractive index RI_{PH}, and RI_{B} is less than RI_{PH}.

6. The device of claim 5, wherein the buffer material is SiO₂.

7. The device of claim 1 wherein the plasmonic resonator is covered with a cladding layer.

8. The device of claim 1 wherein the plasmonic resonator is covered with a cladding layer, wherein the cladding layer comprises a sensing medium, and wherein the sensing medium comprises a porous material selected to attract or trap a target molecule.

9. The device of claim 1, wherein the plasmonic resonator is covered with a cladding layer, wherein the cladding layer comprises a sensing medium, and the sensing medium comprises alumina, titania, or a polymer matrix.

10. The device of claim 1, wherein the plasmonic resonator comprises a material that supports a surface plasmon.

11. The device of claim 1, wherein the plasmonic resonator comprises gold, silver, copper, aluminum, or graphene.

12. The device of claim 1, wherein the device further comprises a photonic waveguide coupled to the photonic resonator.

13. The device of claim 1, wherein the device further comprises a photonic waveguide coupled to the photonic resonator, wherein a transmittance spectrum of light in the photonic waveguide decreases at a resonance wavelength of the plasmonic resonator.

14. The device of claim 1, wherein the photonic resonator has a high intrinsic Q value.

15. The device of claim 1, wherein the photonic resonator has an intrinsic Q value of at least 10,000.

16. The device of claim 1, wherein the plasmonic resonator comprises two or more nanoparticles.

17. The device of claim 1, wherein the plasmonic resonator comprises two or more nanoparticles that are separated by a distance d, wherein d is greater than the width of the nanoparticles.

18. The device of claim 1, wherein the plasmonic resonator comprises two or more nanoparticles that are separated by a distance d, wherein d is greater than five times the width of the plasmonic resonator.

19. A device comprising at least one plasmonic nanoparticle and a photonic wave guide, wherein the photonic wave guide comprises a dielectric material, and the at least one plasmonic nanoparticle is electromagnetically coupled with the photonic wave guide.

20. The device of claim 19, wherein the dielectric material comprises a material having refractive index that is larger than a refractive index of a neighboring layer.

21. The device of claim 19, wherein the dielectric material comprises silicon nitride or silicon.

22. The device of claim 19, wherein the at least one plasmonic nanoparticle comprises gold, silver, copper, aluminum or graphene.

23. The device of claim 19, wherein the device produces a localized surface plasmon resonance in the vicinity of the at least one plasmonic nanoparticle.

24. The device of claim 19, wherein the electromagnetic coupling between the photonic wave guide and the at least one plasmonic nanoparticle achieves a coupling efficiency of at least about 10%.

25. The device of claim 19, wherein the at least one plasmonic nanoparticle comprises two or more plasmonic nanoparticles, and the photonic waveguide couples light to each of the two or more plasmonic nanoparticles.

26. The device of claim 19, wherein the at least one plasmonic nanoparticle comprises two or more nanoparticles that are separated by a distance d, wherein d is greater than the width of the nanoparticles.

27. The device of claim 19, wherein the at least one plasmonic nanoparticle comprises two or more nanoparticles that are separated by a distance d, wherein d is greater than five times the width of the nanoparticles.

28. The device of claim 19, wherein the at least one plasmonic nanoparticle reduces a transmission of light through the photonic waveguide at the resonance wavelength of the at least one nanoparticle by at least 10%.

29. The device of claim 19, wherein the photonic wave guide contains holes in the surface of the photonic wave guide.

30. The device of claim 19, wherein the holes in the photonic wave guide occur at regular intervals.

31. The device of claim 19, wherein the photonic wave guide contains holes in the surface of the photonic wave guide, and the at least one plasmonic nanoparticle is not on top of a hole in the surface of the photonic wave guide.

32. The device of claim 19, wherein the photonic wave guide contains holes in the surface of the photonic wave guide, and the at least one plasmonic nanoparticle is an approximately central position with respect to two or more holes.

33. The device of claim 19, wherein the two or more holes form an approximately symmetric shape around the central position of the at least one plasmonic nanoparticle.
